(19) United States
(12) Patent Application Publication
(10) Pub. No.: US 2001/0048078 A1
(43) Pub. Date: Dec. 6, 2001

(54) Apparatus and method for identifying the source of scattered light

(76) Inventors: Alva Taylor Stair, Concord, MA (US); Paul Christopher Joss, Dracut, MA (US)

Correspondence Address: IANDIORIO & TESKA, 260 BEAR HILL ROAD, WALTHAM, MA, 02451-1018, US

(21) Appl. No.: 09/794,639

(22) Filed: Feb. 27, 2001

Related U.S. Application Data
(60) Provisional application No. 60/186,517, filed on Mar. 2, 2000.

(51) Int. Cl. G01J 5/02; H01J 40/14

(52) U.S. Cl. 250/340; 356/364; 250/221

(57) ABSTRACT

A method for determining the composition of a target includes the steps of sensing radiation in the short wave infrared range scattered by the target, measuring the polarization of the sensed radiation and determining, from the polarization of the sensed radiation, the presence of at least one of water and ice particles in the target area.

### RELATED APPLICATIONS

This application claims priority of U.S. Provisional Application No. 60/186,517 filed on Mar. 2, 2000, titled APPARATUS AND METHOD FOR IDENTIFYING THE SOURCE OF SCATTERED LIGHT.

### FIELD OF INVENTION

This invention relates generally to an apparatus and method for identifying the source of scattered light, and more particularly to an apparatus and method for receiving light reflected from a target area, detecting the polarization of the light and determining the presence or absence of water and ice particles in the target area.

### BACKGROUND OF INVENTION

Light is a form of electromagnetic radiation, which consists of coupled electric and magnetic fields that propagate together through space at the speed of light. Both of the electric and magnetic fields are vector quantities, having both a magnitude and a direction in which they point. In electromagnetic radiation, the electric and magnetic fields are always perpendicular to each other, and both vectors are perpendicular to the direction of propagation of the radiation. The magnitude of both the electric and magnetic fields oscillates and, as the radiation propagates through space, this oscillation has a distinguishing wavelength, which can be used to characterize the radiation. Ordinary light that can be seen with the naked eye, or visible radiation, has an average wavelength of approximately 0.5 microns, depending on the color of the light. Of this visible radiation, violet light has the shortest wavelength of approximately 0.4 microns and red light has the longest wavelength of approximately 0.7 microns. Electromagnetic radiation with wavelengths shorter than that of violet light is known as ultraviolet radiation, whereas radiation with wavelengths longer than that of red light is known as infrared radiation.

Light can be unpolarized, partially polarized or completely polarized. In unpolarized radiation such as sunlight, moonlight, starlight and incandescent light, the direction of the electric field wanders randomly in the plane perpendicular to the direction of propagation of the radiation. If the electric field always lies along a particular line in the plane perpendicular to the direction of propagation of the radiation, the radiation is completely linearly polarized. If the electric field tends to lie along a particular line, but also points in other directions at various times, the radiation is partially linearly polarized.

The polarization of radiation is quantified by the degree of polarization and the angle of polarization. The degree of polarization is the intensity of the radiation that can be ascribed to the time-averaged component of the electric field that lies along the line perpendicular to the direction of propagation called the preferred line, divided by the total radiative intensity. The angle of polarization is the angle between the preferred line and a reference line in the plane perpendicular to the direction of propagation. The degree of polarization varies from 0% for unpolarized radiation to 100% for completely linearly polarized radiation. The angle of polarization can vary from 0° to 180°.

By measuring the polarization of scattered light at particular wavelengths, one can identify the source of the scattered light. For example, by determining the polarization of scattered radiation, it is possible to discriminate between clouds and other sources of radiation, thus providing a useful technique for clutter mitigation. Also, the polarization signature from clouds contains substantial information about whether the particles near the surface of the cloud are formed from water or ice. This information is extremely useful in determining the glaciation of clouds via remote sensing techniques, which would be very helpful for aircraft safety, for numerical weather prediction and for incorporation into global climate models.

### SUMMARY OF THE INVENTION

It is therefore an object of the invention to provide a polarimetric apparatus and method for analyzing scattered light.

It is a further object of the invention to provide such a polarimetric apparatus and method for identifying the source of the scattered light.

It is yet a further object of the invention to provide such a polarimetric apparatus and method for indicating whether light has been scattered by ice particles, water particles or a mixture of ice and water particles.

It is yet a further object of the invention to provide such a polarimetric apparatus and method that is capable of discriminating between light scattered from naturally occurring clouds and light scattered from man-made phenomena such as the plumes from rocket and airplane exhausts.

This invention results from the realization that, by measuring the polarization of scattered light within a certain wavelength band, particularly wavelengths within the 2.5-5 micron absorption band, the nature of the source of the reflected light can be determined. Based on the polarization measurements, it can be determined whether the source of the reflected light is ice, water, a mixture of ice and water or neither ice nor water.

This invention features a polarimetry method for identifying the source of scattered light from water and ice particles, including the steps of sensing radiation in the short wave infrared range scattered from a target area, measuring the polarization of the sensed radiation, and determining, from the polarization of the sensed radiation, the presence of at least one of water and ice particles in the target area.

In a preferred embodiment, the method may also include the step of distinguishing the proportion of water and ice present in the target area. The short wave infrared range may include wavelengths in the range of 2.5-5.0 μm, and preferably wavelengths in the range of 2.8-3.3 μm. The target area may include a cloud and the scattered radiation may include sunlight scattered by the cloud.

This invention also features a method for determining the composition of a target, including the steps of receiving radiation scattered by the target, measuring the polarization of the received radiation in the short wave infrared band, and determining the composition of the target based on the polarization of the radiation in the short wave infrared band which is scattered by the target.

In a preferred embodiment, the composition may be determined to be water, ice, a combination of water and ice or neither water nor ice. The determining step may include comparing the polarization measured in the measuring step to known polarization values for radiation scattered by ice and water.

This invention also features a polarimetric apparatus for determining the presence of at least one of water and ice particles in a target including means for sensing radiation in the short wave infrared range scattered from a target, means for measuring the polarization of the sensed radiation, and means for determining, from the polarization of the sensed radiation, the presence of at least one of water and ice particles in the target.

This invention also features a polarimetric apparatus for determining the composition of a target including means for receiving radiation scattered by the target, means for measuring the polarization of the received radiation in the short wave infrared band and means for determining the composition of the target based on the polarization of the radiation in the short wave infrared band that is scattered by the target.

### BRIEF DESCRIPTION OF THE DRAWINGS

The invention will now be described with reference to the following figures, in which:

FIG. 1 is a schematic diagram that shows how light that is scattered from clouds is received by a detection system in accordance with the present invention;

FIG. 2 is a schematic diagram that shows the components of the detection system used in accordance with the present invention;

FIG. 3 is a block diagram illustrating one embodiment of the method for identifying scattered light in accordance with the present invention;

FIG. 4 is a graph that shows the imaginary component of the index of refraction of ice in the 2-5μm wavelength band;

FIG. 5 is a graph that shows the imaginary component of the index of refraction of water in the 2-5 μm wavelength band;

FIG. 6 is a graph that shows schematically how the degree of polarization of light scattered from ice, water and aircraft exhaust varies with the scattering angle after single scattering and multiple scattering of the light;

FIG. 7 is a graph that shows schematically how the angle of polarization of light scattered from ice, water and aircraft exhaust varies with the scattering angle after single scattering and multiple scattering of the light;

FIG. 8 is a graph that shows schematically the probability of scattering of light varies with wavelength 2.5-3.5 μm in the wavelength band;

FIG. 9 is a schematic diagram that shows how light is scattered from ice and water particles within a cloud; and

FIG. 10 is a graph that shows the relative angles used in the method of the present invention.

### PREFERRED EMBODIMENT

When a ray of unpolarized light, such as sunlight, strikes a cloud particle, it is partially absorbed by the particle and partially scattered into a new direction of propagation. At visible wavelengths, the fraction of incoming light that is scattered rather than absorbed is nearly independent of wavelength, which causes clouds illuminated by sunlight to appear white to the human eye. However, at infrared wavelengths, the ratio of scattering to absorption by water droplets and ice particles varies considerably with wavelength. In fact, in much of the wavelength band between 2.5 μm-5.0 μm, and more particularly 2.8 μm-3.3 μm, incoming radiation is almost completely absorbed by the cloud particles. It is scattered light within this wavelength band which the method of the present invention analyzes to determine the presence of ice or water within a cloud.

As discussed in detail below, within the 2.5 μm-5.0 μm wavelength band, and more particularly the 2.8 μm-3.3 μm wavelength band, most of the light that impinges on ice or water particles in a cloud is absorbed by the particles. The residual light that is scattered is highly polarized. Furthermore, light scattered from ice particles in a cloud will be polarized differently than light scattered from water particles in a cloud, and light emitted by an exhaust plume from a rocket or airplane will be unpolarized. Therefore, based on the different polarization properties of scattered light in the 2.8 μm-3.3 μm wavelength band, the method of the present invention can determine whether a cloud is formed from ice particles, water particles, or if the cloud is not a natural cloud, but a man-made phenomenon.

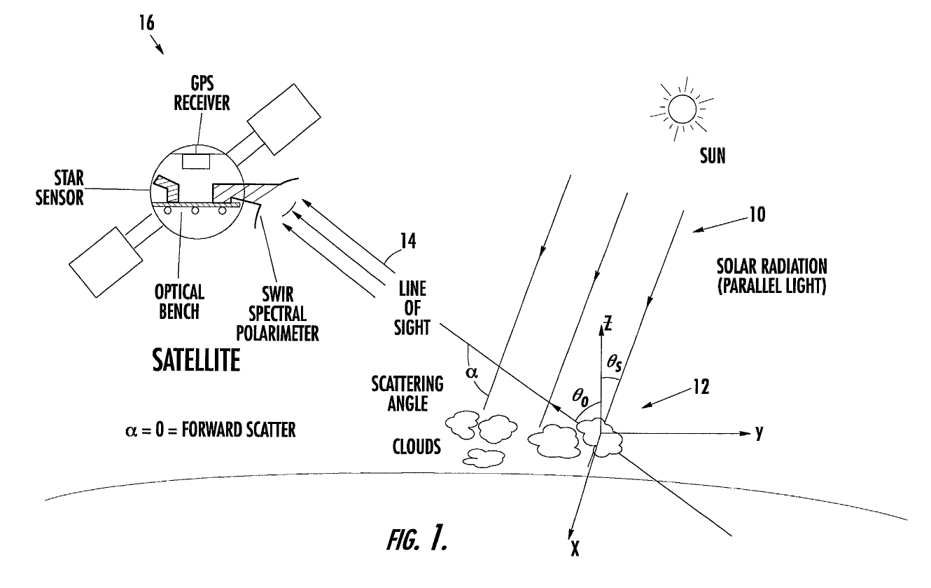

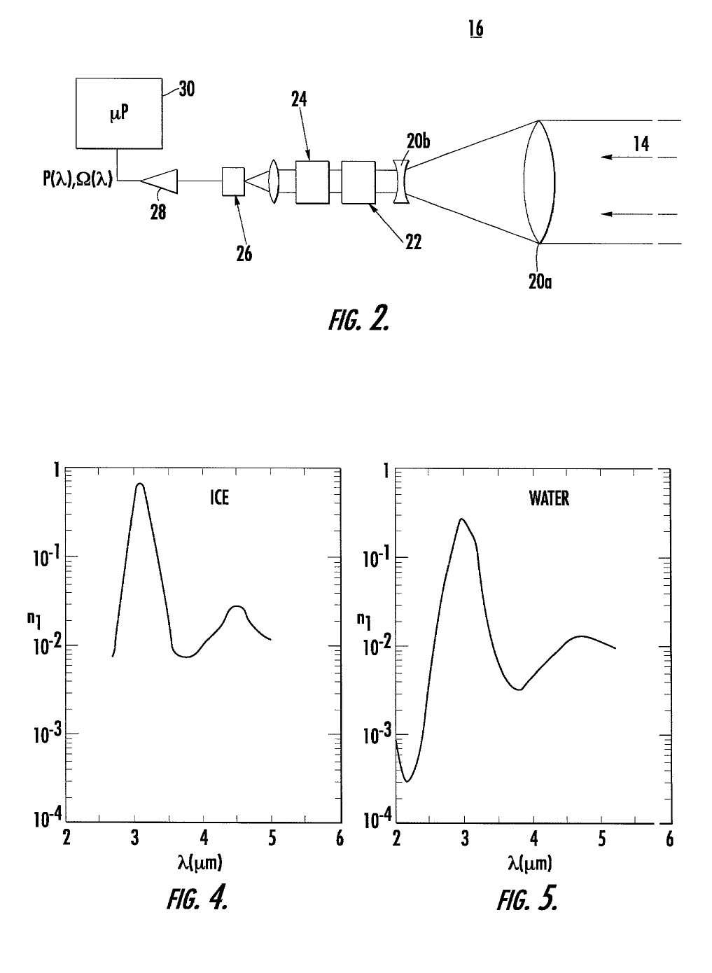

FIG. 1 is a schematic diagram which shows how sunlight that is scattered from clouds is received by a detector. Solar radiation, indicated by arrows 10, reflects from clouds 12, sending scattered light 14 toward detection system 16 at a scattering angle α. Angles θₒ and θₛ represent the angles of the detection system, respectively. Detection system 16, which is shown in greater detail in FIG. 2, is preferably mounted within a satellite.

Detection system 16, shown schematically in FIG. 2, includes a lens system 20a and 20b for collecting the scattered light 14. A polarimeter 22 measures the polarization of the scattered light, and an infrared spectrometer 24 is a bandpass mechanism that only allows light having wavelengths between 2.5 μm and 5.0 μm, and preferably between 2.8 μm-3.3 μm, to pass. The light is then passed through an infrared detector 26 and amplified by amplifier 28. The output of amplifier 28 represents the degree of polarization P and the angle of polarization Ω. Microprocessor 30 receives this output and determines the phase (ice, water, a water-ice mixture, or neither ice nor water) of the target area is determined, as described below.

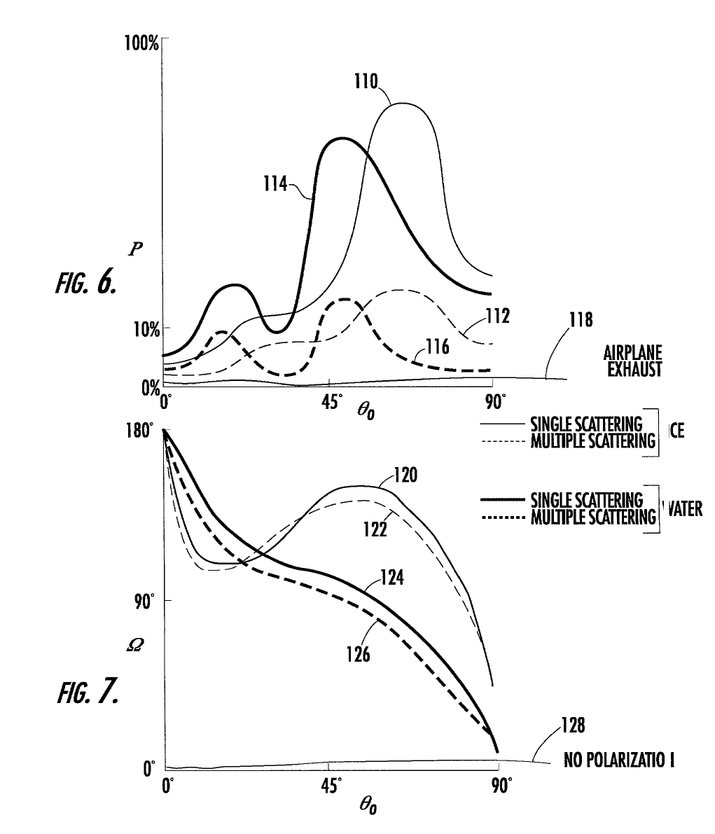

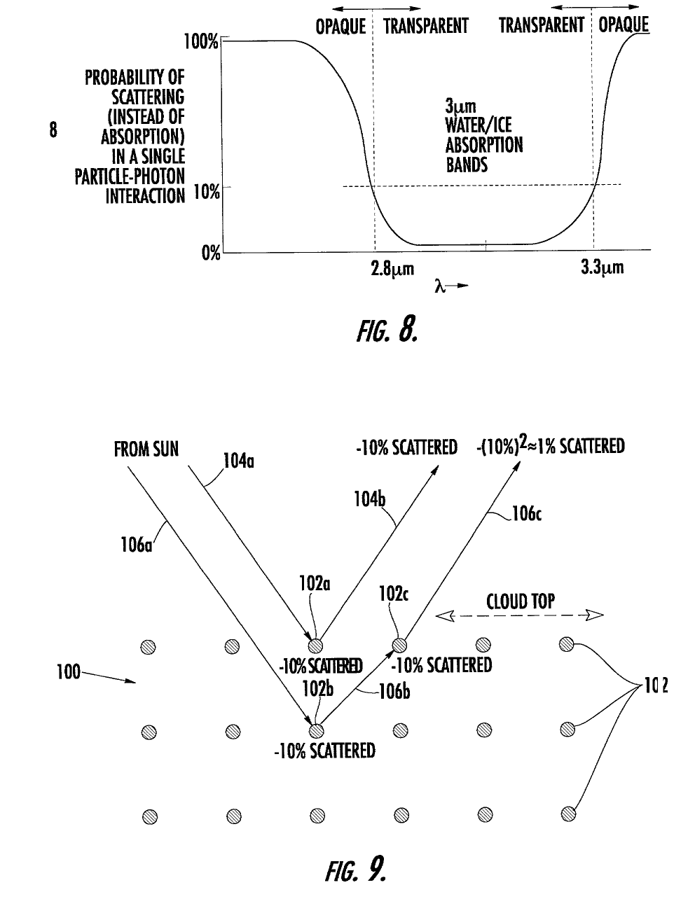

Referring now to FIG. 3, the steps that are performed by the microprocessor 30 of the present invention will be described. First, step 50, light scattered from a target area such as a cloud is received by the lens system 20a and 20b, FIG. 2. The degree and angle of polarization of the scattered light are then determined, step 52, and wavelengths less than 2.5 μm and greater than 5.0 μm, and preferably wavelengths less than 2.8 μm and greater than 3.3 μm, are filtered out, step 54, in infrared spectrometer 24, FIG. 2. The signal is then amplified, step 56, and the form of the target is identified based on the degree of polarization of the filtered signal, step 58. The signal is then compared to a look-up table, step 60, to determine the phase (water cloud, ice cloud, water-ice mixture, or neither ice nor water) of the target area. The look-up table used to identify the phase of the target area is described in greater detail with reference to FIGS. 6 and 7.

Regarding step 58, the degree and angle of polarization for each scattering plane X-Y, X-Z and Y-Z are determined by measuring the intensity of the received light for each of the scattering planes. For simplicity, intensity in the X-Y plane is referred to as I₁, intensity in the X-Z plane is referred to as I₂ and intensity in the Y-Z plane is referred to as I₃. The total intensity I of the received signal is ⅔(I₁+I₂+I₃). The amount of polarized intensity I_{P} is 4/3[I₁²+I₂²+I₃²−I₁I₂−I₁I₃−I₂I₃]^{½}; and the amount of unpolarized intensity I_{U} is I-I_{P}. Based on these figures, the degree of polarization P equals +/−I_{P}/I and the angle of polarization Ω equals cos⁻¹[(I₁−½I_{U})/(I₁−I_{U})]^{½}.

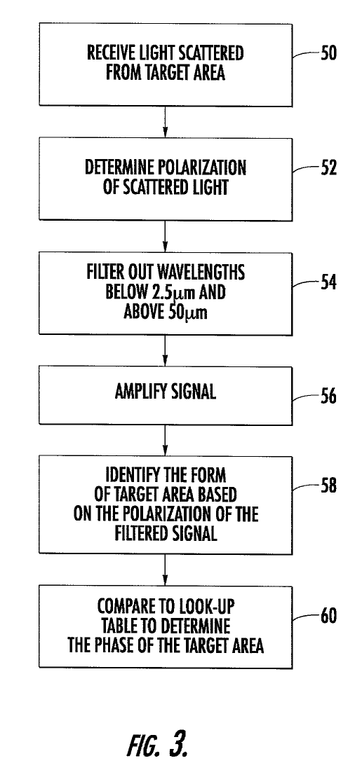

FIGS. 4 and 5 are graphs which show the value of the imaginary component, n_{I,}, of the index of refraction for ice and water, respectively, as a function of wavelength. As can be seen in FIGS. 4 and 5, the maximum values of n₁ occur in the range of approximately 2.8 μm to 3.3 μm. Within this band, the absorption of light incident on ice and water particles is maximized and multiple scattering of the light is minimized. Therefore, as discussed below, it is within this band that the phase of clouds from which light is reflected (water clouds, ice clouds, a combination, or neither) is most identifiable and distinguishable.

As discussed above, when a light ray enters a cloud, it may be scattered by a water particle or an ice particle, or it may be absorbed by a water or ice particle. Since, as the number of scattering events experienced by the light ray increases, the amount of polarization of the light ray decreases, it is desirable to decrease the probability of receiving light rays which have been scattered multiple times and to increase the probability of receiving light rays which have been scattered only once. Since the probability of scattering of a light ray, relative to the probability of its absorption by a cloud particle, is dependent on the wavelength of the light ray, it is important to analyze light which falls within a wavelength band in which most of the light ray is absorbed by the ice or water particle so any light that has not been absorbed will have been scattered only once and then reflected away from the cloud. Thus, singly scattered light rays are preferable because the degree of polarization for singly scattered rays is generally much higher than those that have undergone multiple scattering, resulting in a polarization signal which can be measured much more readily. Accordingly, in the present invention, the number of doubly or multiply scattered light rays is reduced and the number of singly scattered rays that are received by the detection system 16, FIG. 2, are increased. Hence the present invention exploits the unique properties of the 2.5 μm to 5.0 μm wavelength band, and especially the 2.8 μm to 3.3 μm wavelength band.

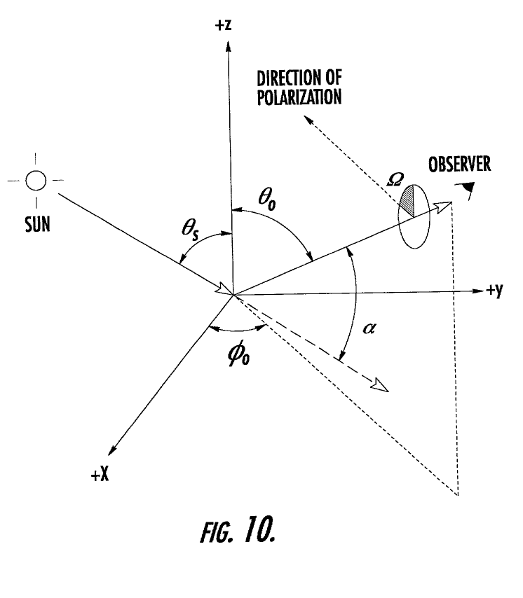

FIG. 8 is a graph that shows schematically the probability of scattering to absorption of light within the 2.8 μm to 3.3 μm wavelength band. As illustrated in FIG. 8, within the wavelength band between 2.8 μm and 3.3 μm, the probability for scattering is generally less than 10% of the probability for absorption. Since most of the light rays are absorbed by the ice and water particles in this wavelength band, a majority of the light rays that have been scattered away from the cloud have only been singly scattered. As discussed above, this singly scattered light which the present invention analyzes in order to determine the volume phase of the cloud particles. This scattering phenomenon is schematically shown in FIG. 9. In the figure, a cloud 100 is formed from a number of particles 102, which may be ice or water particles, or both. When a light ray 104a impinges on a particle 102a, typically 90% or more of the light ray in the 2.8 μm to 3.3 μm wavelength band are absorbed by the particle and 10% or less of the light ray in this band is scattered in the manner light ray 104b. Similarly, when a light ray 106a impinges on a particle 102b, typically 90% or more of the light ray in the 2.8 μm to 3.3 μm wavelength band is absorbed and 10% or less of the light ray in this band scattered in the manner of light ray 106b. However, when the light ray 106b impinges on particle 102c, no more than 10% of light ray 106b is scattered on 1% of the original light ray 106a. Since the light ray 104b has only been singly scattered, its degree and angle of polarization will be much greater than the degree of polarization of the light ray 106c, which was multiply scattered. Therefore, since a very small amount of the light rays reflected from the cloud 100 are multiply scattered in the 2.8 μm to 3.3 μm wavelength band, the effect of these light rays is negligible in the determination of the degree and angle of polarization of the reflected light rays.

FIGS. 6 and 7 are graphs which show schematically the effect of multiple scattering on the degree P the angle Ω of polarization, respectively, for ice, water and airplane exhaust. In FIG. 6, P is shown schematically as a function of the angle θₒ, with the angles θₛ and φₒ, which is the azimuthal angle of the source of radiation (the sun, for example) with respect to the detection device or observer, FIG. 10, held constant. Thin solid line 110 shows P for light that is singly scattered from ice crystals, and thin broken line 112 shows P for light that is multiply scattered. Thick solid line 114 shows P for light that is singly scattered from water droplets, and thick broken line 116 shows P for light that is multiply scattered from water particles. Solid line 118 shows P for light that is from a man-made “cloud”, such as an airplane or rocket exhaust plume.

Similarly, in FIG. 7, thin solid line 120 shows the angle of polarization Ω for light that is singly scattered from ice crystals and thin broken line 122 shows Ω for light that is multiply scattered from ice particles. Thick solid line 124 shows Ω for light that is singly scattered from water droplets and thick broken line 126 shows Ω for light that is multiply scattered from water particles. Solid line 128 shows Ω for light reflected from a manmade “cloud”, such as an airplane or rocket exhaust plume.

Since the scattered light is being received by an aircraft or satellite that is moving with respect to the target area, several measurements of the polarization of the light received by the detection system 16 are taken at different observation angles θₒ in order to more definitively determine the degree and angle of polarization. If, after the procedure shown in FIG. 3, the degree P and/or the angle of polarization Ω is determined to be between the ice and water lines shown in FIGS. 6 and 7, respectively, it can be assumed that the phase of the target is a mixture of water and ice particles. The proportion of ice to water is determined by the ratio of the degree and angle of polarization. For example, if the measured degree of polarization is exactly between the values for ice and water shown in FIG. 6, the target is determined to be 50% ice and 50% water.

An analysis of the graphs of FIGS. 6 and 7 allows several conclusions to be drawn. First, it can be seen that there is a significant difference in the degree of polarization, FIG. 6, for light rays that are singly scattered relative to those that are multiply scattered, both by ice and water particles. While the difference in the angle of polarization, FIG. 7, is less dramatic, it is still quite significant. Second, since the degree and angle of polarization signatures of ice and water are different, once the degree and angle of polarization for a given scattering geometry is determined empirically, the composition of the particles within the cloud that reflected the received light can be ascertained by referring to the theoretical expectations, as illustrated schematically in FIGS. 6 and 7.

Although the invention has been described as a method for analyzing sunlight reflected upwardly from a target area and received by a detection system located on an aircraft or satellite, it will be understood that the method of the present invention may be used in conjunction with a ground-mounted detection system for receiving light reflected downwardly from a target area. Furthermore, the method may be used to identify the presence of sold ice and liquid water on the surface of the earth and on other solid surfaces, such as aircraft wings.

Although specific features of the invention are shown in some drawings and not in others, this is for convenience only as each feature may be combined with any or all of the other features in accordance with the invention.

Other embodiments will occur to those skilled in the art and are within the following claims:

What is claimed is:

1. A polarimetry method for identifying the source of scattered radiation from water and ice particles comprising:
sensing radiation in the short wave infrared range scattered from a target area;
measuring the polarization of the sensed radiation; and
determining, from the polarization of the sensed radiation, the presence of at least one of water and ice particles in the target area.

2. The polarimetry method of claim 1, further including the step of distinguishing the proportion of water and ice present in the target area.

3. The polarimetry method of claim 1 wherein the short wave infrared range includes wavelengths in the range of 2.5-5.0 μm.

4. The polarimetry method of claim 3 wherein the short wave infrared range includes wavelengths in the range of 2.8-3.3 μm.

5. The polarimetry method of claim 1 wherein the target area includes a cloud.

6. The polarimetry method of claim 5 wherein the scattered radiation includes sunlight scattered by the cloud.

7. A method for determining the composition of a target, comprising the steps of:
receiving radiation scattered by the target;
measuring the polarization of the received radiation in the short wave infrared band; and
determining the composition of the target based on the polarization of the radiation in the short wave infrared band which is scattered by the target.

8. The method of claim 7 wherein the short wave infrared band includes wavelengths in the 2.5-5.0 μm range.

9. The method of claim 8 wherein the short wave infrared band includes wavelengths in the 2.8-3.3 μm range.

10. The method of claim 8 wherein the composition may be determined to be water, ice, a combination of water and ice or neither water nor ice.

11. The method of claim 10 wherein said determining step comprises comparing the polarization measured in the measuring step to known polarization values for radiation scattered by ice and water.

12. The method of claim 7 wherein the target comprises a cloud.

13. The method of claim 12 wherein the radiation scattered by the target comprises sunlight.

14. A polarimetric apparatus for determining the presence of at least one of water and ice particles in a target comprising:
means for sensing radiation in the short wave infrared range scattered from a target;
means for measuring the polarization of the sensed radiation; and
means for determining, from the polarization of the sensed radiation, the presence of at least one of water and ice particles in the target.

15. A polarimetric apparatus for determining the composition of a target, comprising:
means for receiving radiation scattered by the target;
means for measuring the polarization of the received radiation in the short wave infrared band; and
means for determining the composition of the target based on the polarization of the radiation in the short wave infrared band which is scattered by the target.
